(19) United States
(12) Patent Application Publication
(10) Pub. No.: US 2010/0225039 A1
(43) Pub. Date: Sep. 9, 2010

(54) Angled wood holder

(76) Inventor: Robert Kevin MacLean, Niagara On The Lake (CA)

Correspondence Address: Robert MacLean, 1285, Line #9, RR#1, Niagara On The Lake, ON, L0S 1J0, CA

(21) Appl. No.: 12/655,403

(22) Filed: Dec. 30, 2009

Related U.S. Application Data
(60) Provisional application No. 61/203,837, filed on Dec. 30, 2008.

(51) Int. Cl. B25H 1/00

(52) U.S. Cl. 269/289 R

(57) ABSTRACT

This invention relates to an angled wood holder for logs, branches, construction lumber and piping. This invention related to a log holder, kindling/branch holder, construction lumber holder and pipe holder for the purpose of safely and easily cutting wood and pipe with power tools and hand tools such as chain saws, circular saws, reciprocal saws and hand saws.

This application claims benefit under the filing date of earlier filed provisional application Ser. No. 61/203,837 filed Dec. 30, 2008 in the name of the same inventor.

### BACKGROUND AND SUMMARY OF THE INVENTION

Cutting firewood, log and branches, has been historically problematic due to the challenge of stabilizing the wood in a safe manner prior to and during the cutting process. In addition, the current practice of stabilizing logs on other logs on the ground and/or attempting to cut branches on the ground can be very difficult and dangerous, as logs can slip and move during the cutting process. This instability of the wood can make the cutting process dangerous. In addition, cutting wood while it is on the ground can both dull the chain blade instantly if it comes into contact with the ground and/or cause a dangerous kickback of a saw which can be very harmful and even deadly.

Currently wood cutting holders such as saw horses or other wood holders are readily available to hold wood for the purpose of cutting mostly construction lumber. These saw horses need to be used in pairs and will support construction lumber horizontally after it is lifted into position.

However, the conventional saw horse does not allow for the cutting of timber such as logs and branches for the purpose of firewood and yard clean-up. The problem with conventional wood cutting aids like saw horses and other wood holders is that they can be problematic and inefficient due to their size, shape and form for cutting firewood. The current form of a saw horse generally needs a second person to hold the wood while cutting or needs additional accessories to clamp the wood in place to secure wood while cutting. The wood also needs to be fully lifted up in its entirety and onto the saw horse which is also problematic and difficult.

It would be more efficient, easier and safer if there existed a lightweight and portable V shaped or concave and angled devise that could elevate and cradle the wood easily by one person, so as to allow for the cutting of wood at one end, yet also allow for ground support on the opposite end to support the weight and also to stabilize the timber, firewood, logs and branches while cutting.

An alternative proposal is taught in U.S. Pat. No. 4,641,822 for an invention titled “Wood Holder”. In that Patent, there is taught a wood holder for cantilever support of one or more cantilever logs or lumber pieces. The problem with this prior invention is that it is large and cumbersome and is not easily portable to the work location; the product also needs to be supported by a counter weight such as heavy rocks. Another problem with this invention is that the logs must be lifted in their entirety up to the height of the holder in order to cut the wood. This can and may be difficult and may need to include a second person for help. This product falls short of achieving a lightweight, portable and V shaped angled wood cutting support needed to easily elevate wood, hold the weight and secure the wood for safe and easy cutting by one person.

It is an object of the present invention to provide a lightweight, portable V shaped angled wood cutting support that allows for an easier and safer way to not only aid in the cutting of timber, logs, and branches, but also construction lumber and piping of many sizes.

Other objects and achievements of the invention will be apparent to those skilled in the art upon reading the specifications and claims included herein.

According to the aspect of the present invention, there is provided an angled wood holder for logs, branches, construction lumber and piping, comprising: a concave or V shaped devise that cradles the wood off the ground at an ANGLE to allow for the weight of the wood to be supported by both the invention and the ground at the same time, concave foot impressions for additionally supporting smaller pieces of wood with the foot while cutting; four peg holes and screw holes that accept ground pegs or screws and allow for additional stability and safety while cutting; multiple lumber ridges along both V shaped interior side walls of the devise that support construction lumber such as 2×2, 2×4, 2×6, 2×8 & 2×10 also at a ground supported angle for cutting; piping ridges at or near the bottom of the V shaped interior side walls of the devise that support pipe while cutting; a seriated base along the entire bottom edge of the invention for additional grip against the ground while cutting.

### BRIEF DESCRIPTION OF THE DRAWINGS

The invention will be readily understood after reading the following descriptions of the invention given in conjunction with the drawings, in which:

FIG. 1 is an illustration showing the angled wood holder in operation for aiding in the cutting of timber such as a log.

FIG. 2 is another illustration showing more clearly the angle allowed by the wood holder in FIG. 1 for the cutting of timber such as a log.

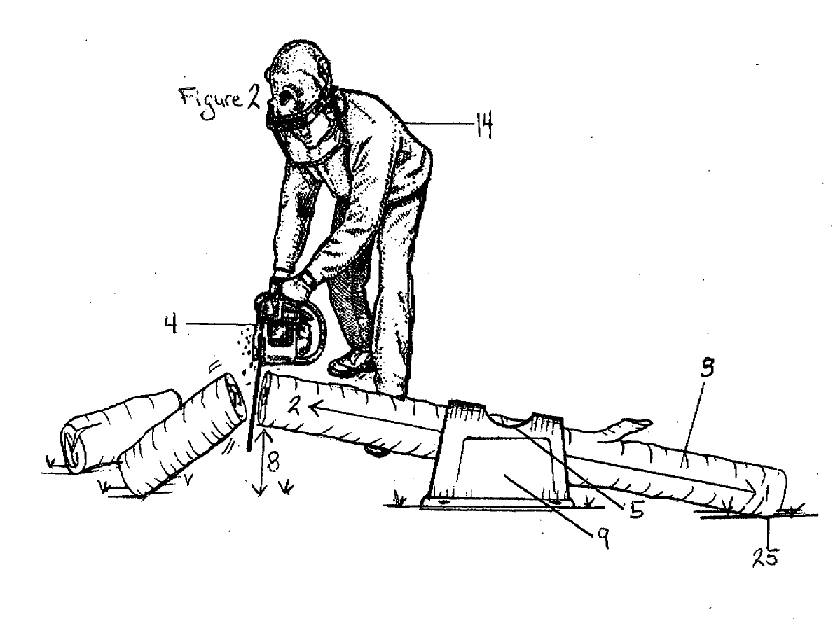

FIG. 3 is an illustration of the angled wood holder in FIG. 2 showing that only one end of the log needs to be lifted and placed onto the angled wood holder in preparation for use.

FIG. 4 is another illustration showing the angled wood holder in operation for aiding in the cutting of most construction lumber such 2×2, 2×4, 2×6, 2×8, 2×10.

FIG. 5 is an illustration showing the angled wood holder in operation for aiding the cutting of multiple logs, branches or brush.

FIG. 6 is an illustration showing a front view of the angled wood holder supporting a pipe. This illustration shows another secondary use of the angled wood holder.

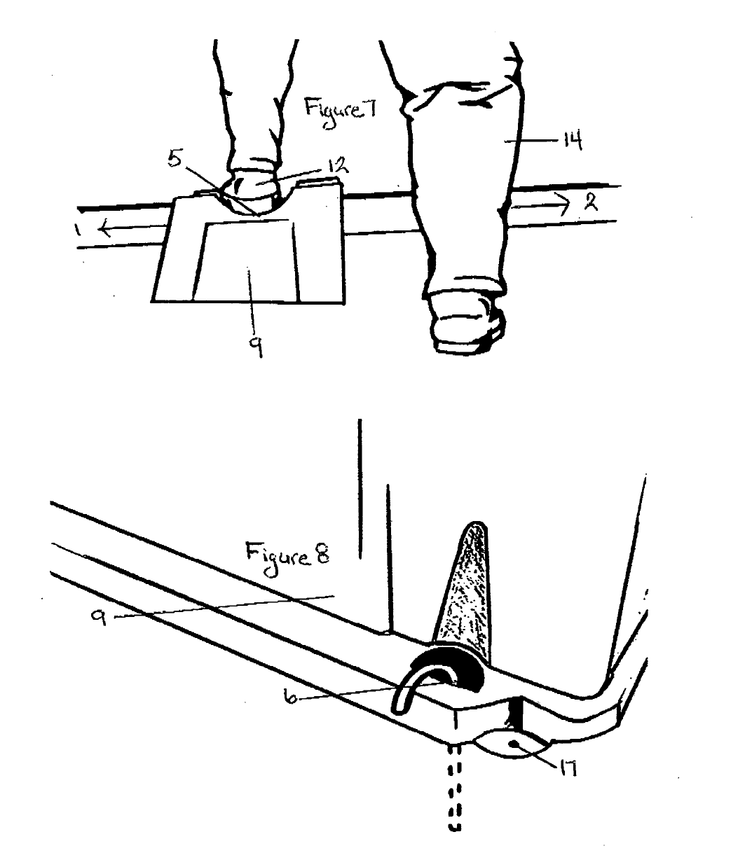

FIG. 7 is an enlarged illustrated side view of the angled wood holder showing the allowed general angle of the wood and also the concave foot depressions for stabilizing smaller pieces of wood while cutting such as in FIG. 4.

FIG. 8 is an enlarged illustrated view of one of the peg holes or screw hole of the present invention that can accept any conventional ground peg or screw for additional stability of the angled wood holder to the ground.

FIG. 9 is an illustration showing the angled nature of the wood holder for supporting logs or construction lumber by the ground on the down angle end.

FIG. 10 is an enlarged side and back view of the angled wood holder showing more perspective of the angled nature of the entire wood holder as well as the construction lumber ridges.

FIGS. 11a & 11b are enlarged illustrations showing how many and what types of wood and pipe can fit in the present invention.

FIG. 12 is an illustrated top view of the present invention showing a better perspective of the 45 degree markers on the angled lumber support ridges.

### DESCRIPTION OF THE PREFERRED EMBODIMENT

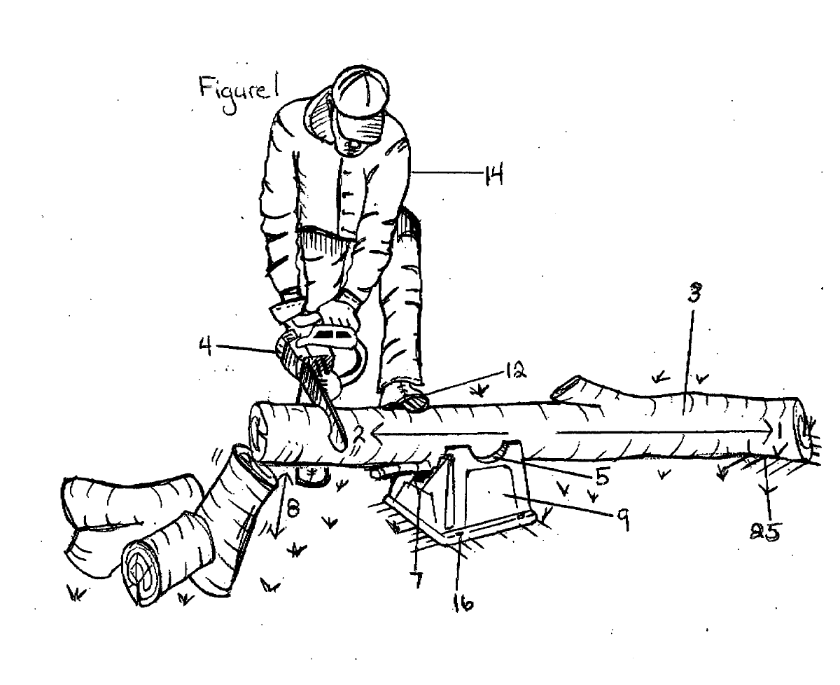

FIGS. 1 & 2 show in perspective the use of the angled wood holder 9 for the purpose of cutting wood, such as a log 3, where 1 shows the downward allowed angle to support and stabilize the weight of the log 3 on the ground side 25 with and by the ground and also by the current invention 9, where 2 shows the upward allowed angle allowing the log 3 to be lifted and elevated by the current invention 9 at a safe distance above the ground 8 while cutting with a power or hand tool 4.

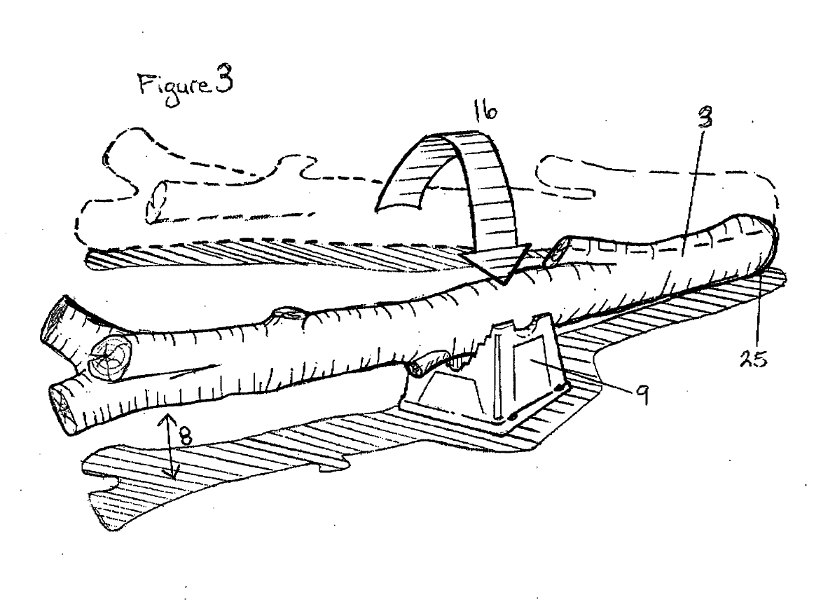

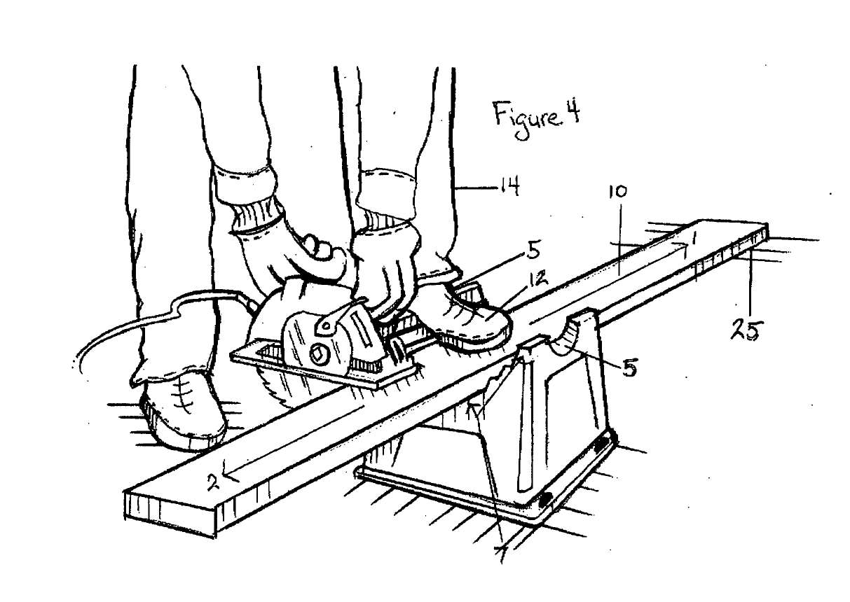

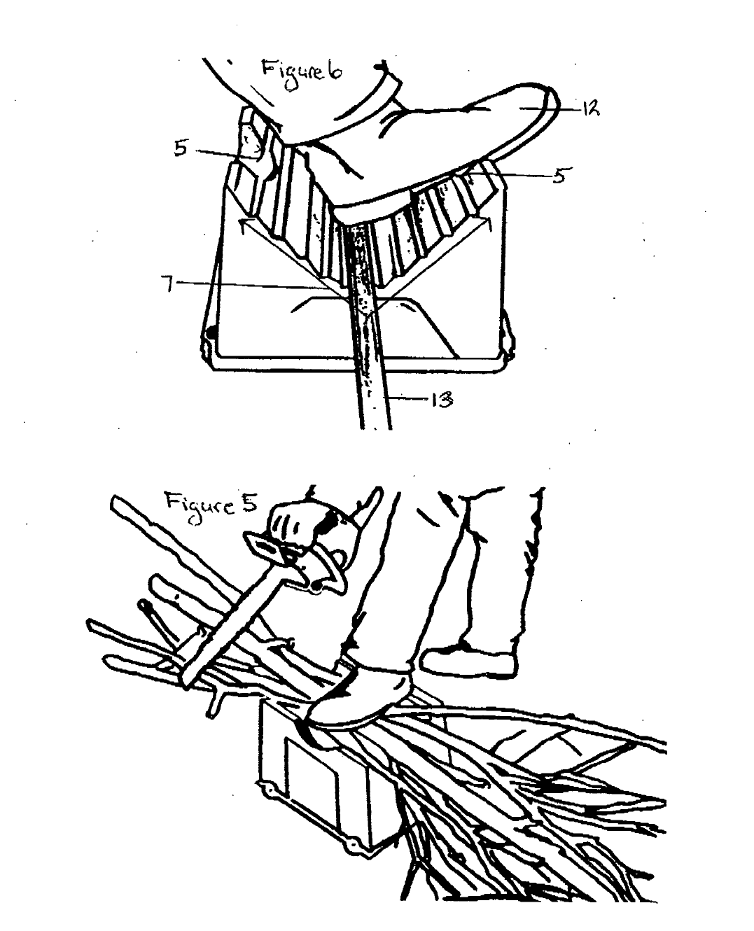

More specifically, the angled wood holder 9 can be used to facilitate the cutting of a log 3 or construction lumber 10 as seen in FIG. 4 or multiple branches 11 as seen in FIG. 5. The light weight of the current invention 9 also allows for it to be portable and placed at any location needed. As seen in FIG. 3 the invention can be placed at a location that makes it easy and possible for the user to lift up ONLY one side of the log 3 in order to place it on the angled wood holder 9. This is a safer way to set up the cutting process as the entire log 3 does not need to be lifted in its entirety into place before cutting as seen in FIG. 3 as seen in numeral 16. This allows the current invention 9 to be used easily by one person 14 as seen in FIGS. 1 & 2.

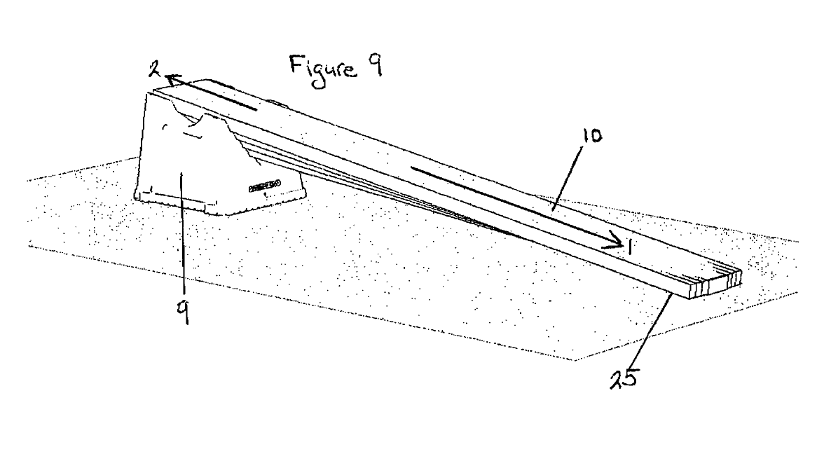

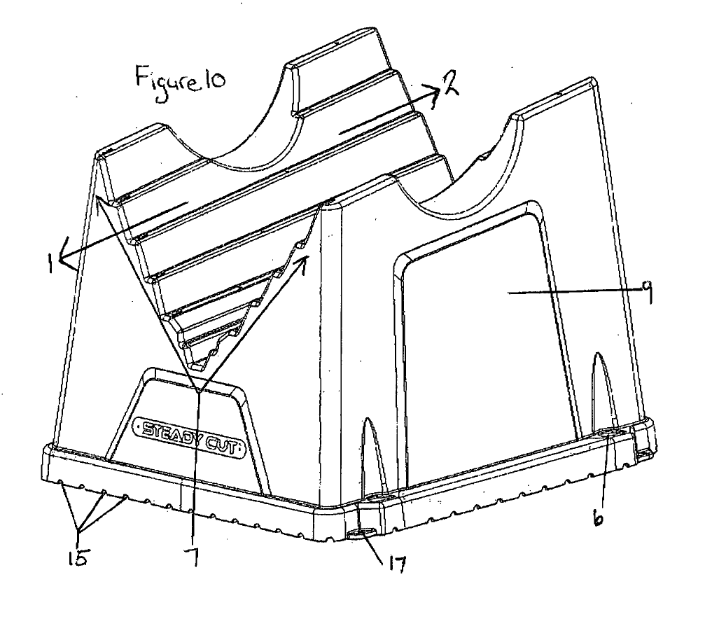

As can be seen in FIGS. 4, 5 & 6, the concave or V nature 7 of the current invention also allows for the user to secure multiple branches 11, lumber 10 and pipe 13 by the users foot 12 placed inside or near the concave foot impressions 5 to secure materials inside the angled wood holder 9 for safer cutting. FIG. 7 shows a side view of the current invention 9 that gives a side perspective of the allowed upward angle 2 and allowed downward angle 1 of the wood 3. FIG. 7 also shows another perspective of the concave foot impression 5 in the side and interior walls of both sides and how this helps to allow the users foot 12 to secure wood inside the current invention 9 while cutting. The peg hole design 6 shown in FIG. 8 that accepts ground pegs on all four corners for additional devise support while cutting on the ground. FIG. 8 also shows an enlarged view of the screw hole design 17 that can accept screws on all four corners for additional devise support while cutting on sub-floor or base.

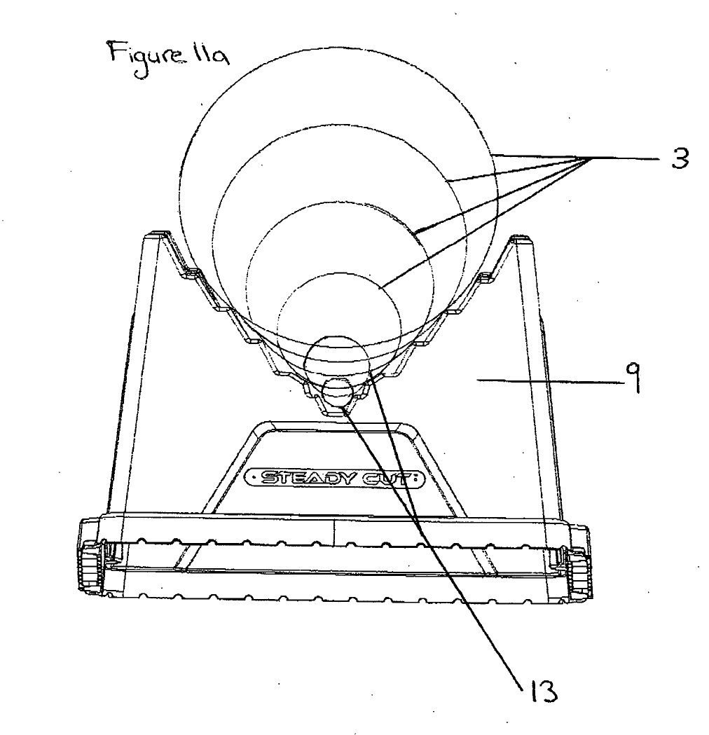

As seen in FIG. 9, the angle of the current invention allows wood, in this case lumber of sizes 2×4, 2×6, 2×8 and 2×10 referred to as numeral 10, to touch the ground 6 on the downward angle end 1 and therefore the weight of the lumber 10 is supported by the ground 6 and by the current invention 9 at the same time. Any general angle that is necessary to facilitate the lumber being able to touch the ground 6 while sitting inside the current invention 9 is essential to the design of the invention 9 that allows it to be useful for cutting lumber 10 and other wood or piping easily. Another part of the current invention 9 that is essential to its usefulness is the opposite upward allowed angle 2 as seen in FIG. 9 that elevates the lumber 10 or any other wood in order to allow the user to cut lumber 10 or other types of wood when raised above the ground at a safe distance.

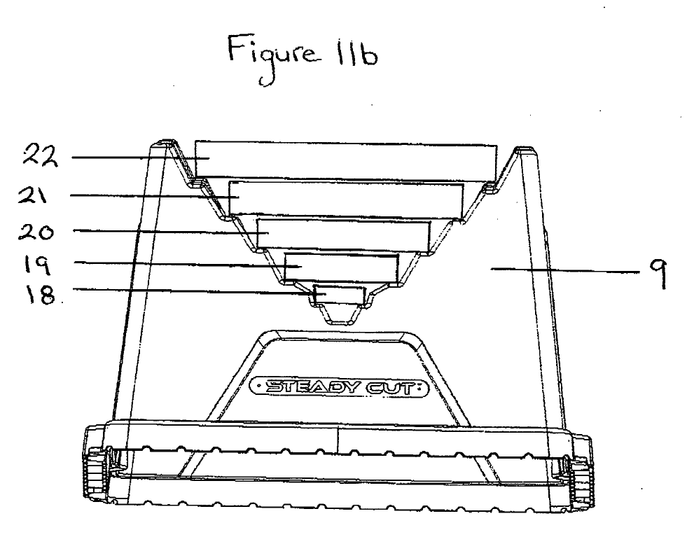

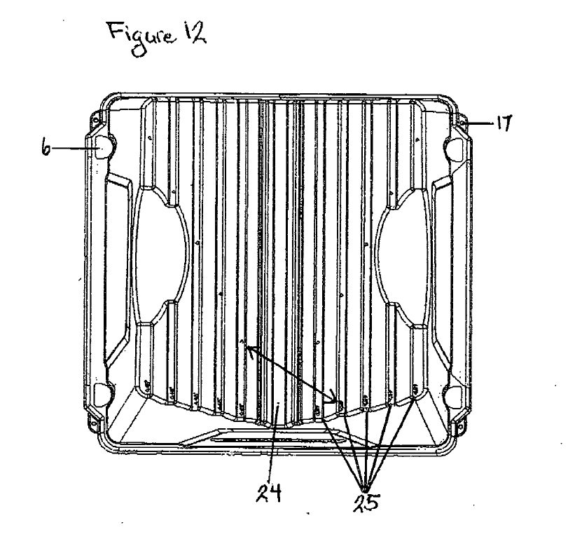

An enlarged view of the current invention 9 as seen in FIG. 10 illustrate the devise on a flat surface showing the nature and degree of the upward angle 2 and downward angle 1 in more detail relative to a flat surface. FIG. 10 also shows all the component pans to the current invention 9, such as the concave or V natured platform of the devise 7, concave foot impressions on both side walls 5, the upward 2 and downward 1 allowed angle, the peg hole locations on the corners 6, and the serrated bottom grooves 15 for additional grip to the ground. It will be noted in FIGS. 11a and 11b of the variety of wood that can be cut within the current invention 9. As seen in FIG. 11a, logs 3 of many sizes and piping 13 fit inside the concave or V nature of the current invention 9. As seen in FIG. 11b, lumber 10, of many sizes can fit inside the concave or V nature of the devise, all lumber sitting within its respective lumber ridge inside the angled platform of the invention 9. Lumber ridges are included for sizes such as 2×2 seen in numeral 18, size 2×4 seen in numeral 19, size 2×6 seen in numeral 20, size 2×8 seen in numeral 21 and size 2×10 as seen in numeral 22.

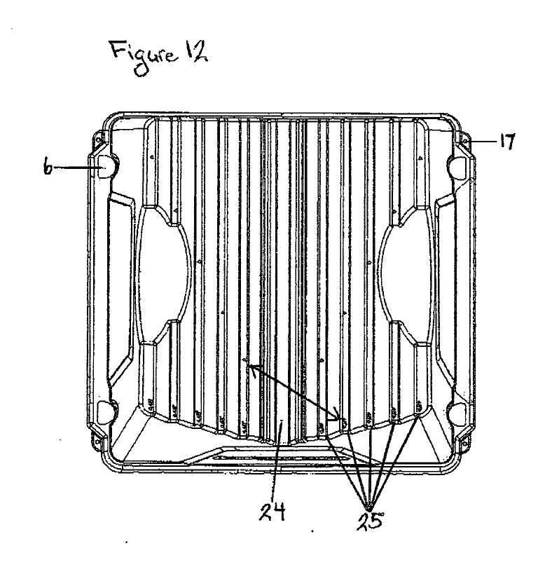

A top down view of the current invention 9 in FIG. 12 shows all the component parts of the devise which include the markings on the devise 23 that allow for pencil points 24 of 45 degree marks to construction wood when placed in its respective and correct lumber ridge as per FIG. 11b for cutting 45 degree angles.

The above description is of the preferred embodiment only and it is not intended that the description be read in a limited manner. Variations from the preferred embodiment without deviating from the scope of the invention will be apparent to those skilled in the art.

The invention is as defined in the appended claim:

1. A portable angled wood holder devise comprising
a concave or V shaped platform that can cradle and hold logs, lumber and piping inside the devise in an elevated and angled position
a devise that includes within it a generally angled platform, allowing for a downward angle to support and stabilize the weight of the wood on the ground with and by the ground and by the angled wood holder
a devise that includes within it a generally angled platform allowing for an upward angle for lifting and elevating the wood by the angled wood holder at a safe distance above the ground for cutting
supporting lumber ridges inside the devise having a generally angled nature so as to allow lumber to be elevated above the ground on one end and supported by the ground on the other end
said devise including concave foot impressions in the side and interior walls
means to fasten the devise to the ground or a base for additional stability.
